(19) United States
(12) Patent Application Publication
(10) Pub. No.: US 2010/0167858 A1
(43) Pub. Date: Jul. 1, 2010

(54) NARROW SEAL CHAIN

(76) Inventors: Jun BABA, Ishikawa (JP); Shuji Sakaguchi, Ishikawa (JP); Ken Nishihata, Ishikawa (JP)

Correspondence Address: WENDEROTH, LIND & PONACK, L.L.P., 1030 15th Street, N.W.,, Suite 400 East, Washington, DC, 20005-1503, US

(21) Appl. No.: 12/645,896

(22) Filed: Dec. 23, 2009

(30) Foreign Application Priority Data
Dec. 25, 2008 (JP) 2008-329119

(51) Int. Cl. F16G 13/06; F16G 13/02; F16G 13/07; F16G 13/00

(52) U.S. Cl. 474/231

(57) ABSTRACT

In a seal chain having ring-shaped seals sealed between outer plates and inner plates, by reducing the thickness of the outer plates and the inner plates, a distance between inner side surfaces of the both inner plates and a distance between outer side surfaces of the both outer plates are set to be same as those of a standard chain, and the length of pins is set to be same as that of the standard chain, so that a narrow seal chain in which a standard guide can be used, and a standard attachment can be attached is achieved.

### BACKGROUND OF THE INVENTION

1. Field of the Invention

The present invention relates to a narrow seal chain having seal rings sealed between inner plates and outer plates.

2. Prior Art

FIGS. 4A and 4B show standard chain (ISO606-08A) in the prior art in which seal rings are not sealed. FIG. 4A is a plan view and FIG. 4B is an enlarged cross-sectional view taken along a line 4B-4B in FIG. 4A. The chain includes outer plates (a), inner plates (b), pins (c), bushes (d), and rollers (e), and is formed into an endless form by inner links (f), (f), . . . and outer links (g), (g), . . . coupled bendably to each other.

The inner link (f) is formed by press-fitting two bushes (d), (d) into holes in the inner plates (b), (b) parallel to each other, and supporting the rollers (e), (e) on outer peripheries of the bushes (d), (d) so as to rotate about axes thereof, and the outer link (g) is formed by press-fitting two pins (c), (c) into holes in the two outer plates (a), (a). Therefore, power transmission is achieved by being wound around both sprockets.

FIGS. 5A and 5B show a seal chain in the prior art. FIG. 5A is a plan view, and FIG. 5B is an enlarged cross-sectional view taken along a line 5B-5B in FIG. 5A. The seal chain includes the outer plates (a), the inner plates (b), the pins (c), the bushes (d), the rollers (e), and ring-shaped seals (h), and is formed into an endless form by the inner links (f), (f), . . . and the outer links (g), (g), . . . coupled to each other so as to be bendable like the standard chain in FIGS. 4A and 4B. In this manner, with the provision of the ring-shaped seals (h), (h), . . . between the outer plates (a), (a) . . . and the inner plates (b), (b), . . . sealed therein, grease injected in gaps between the pins (c) and the bushes (d) is sealed without flowing out, so that elongation of the chain is restrained.

When the standard chain in FIG. 4A and the seal chain in FIG. 5A are compared, both thickness B0 of the outer plate (a) and the inner plate (b) are same. However, a width B4 of the seal chain having the seals (h) sealed between the outer plate (a) and the inner plate (b) is larger than a width b4 of the standard chain which does not have the seals (h) sealed therein. The relation between inner widths between the both outer plates (a), (a) is B3>b3, as a matter of course.

The chain which transmits power is used in a limited narrow space in many cases and, when an attempt is made to wind the seal chain shown in FIGS. 5A and 5B on sprockets on which the standard chain shown in FIGS. 4A and 4B are mounted, there arise various problems. Since the distance between inner side surfaces of the both inner plates (b), (b) of the seal chain is same, it can engage the sprockets. However, the distance between outer side surfaces of the both outer plates (a), (a) is large and the length of the pin (c) is increased, and hence there may be a case where it cannot be mounted depending on the available space. For example, a guide for the standard chain cannot be used, and a standard attachment cannot be attached.

FIG. 6 shows the standard chain with plastic covers (i), (i), . . . attached thereto, which is configured to be used when conveying articles and to travel along a guide (j). The plastic covers (i) are attached so as to cover an outer peripheral portion and both side portions of the chain, and have dimensions that allow attachment to the standard chain such as 08A, 10A, and 12A of ISO606. Therefore, the standard plastic covers (i) cannot be attached to the seal chain shown in FIGS. 5A and 5B, so that fabrication of plastic covers having larger dimensions is required.

As the seal chain in the prior art, for example, “seal chains” disclosed in JP-A-2004-256262 and JP-A-2003-314628 are known.

### SUMMARY OF THE INVENTION

Accordingly, in order to solve the problems arising by enlargement of the width of a seal chain having ring-shaped seals sealed between outer plates and inner plates, it is an object of the invention to provide a narrow seal chain which satisfies dimensions (inner width, total width) of a standard chain in the prior art, and has a strength equivalent to a standard seal chain.

Accordingly, there is provided a narrow seal chain including: outer links having a pair of outer plates and two pins coupling the outer plates; inner links having two bushes configured to couple a pair of inner plates and rollers fitted on an outer peripheries of the bushes; a ring seal sealed between the outer plate and the inner plate, in which the distance between inner side surfaces of the both inner plates and the distance between outer side surfaces of the both outer plates are set to be same as those of a standard chain, and the length of the pin is set to be same as that of the standard chain or the difference in length of the pin is set to be within 10% of that of the standard chain by reducing the thickness of the outer plates and the inner plates.

Preferably, an inner width b3 of the outer link is set to make an amount of deflection of the pin expressed by V=5W(b3)⁴/384EI, where b1 (mm) is an inner width of the inner link, b4 (mm) is a total width of the same, V is the amount of deflection of the pin, W(N) is a force applied to the pin (tensile force applied to the chain), and EI is a Young's modulus, to be 70% or less of a standard seal chain, and a thickness b0 of the plate is set to be 75% or more of the standard seal chain.

Preferably, the outer plates and the inner plates are formed of steel containing C: 0.42 mass % or more, Si: 0.15 to 0.35 mass %, Mn: 0.6 to 0.9 mass %, P: 0.03 mass % or less, S: 0.035 mass % or less, Cr: 0.2 mass % or less, and Ni: 0.2 mass % or less, which has a mixed structure of bainite and martensite as a heat treated structure, contains residual austenite of 20% or less, and has a hardness of 45 HRC or higher.

In other words, in the narrow seal chain in the invention, the both thickness of the outer plate and the inner plate are reduced, and the width (gauge) of the seal is reduced, so that a distance between the fulcrum points of the pins is reduced and the hardness of the outer plate and the inner plate after heat treatment is increased, so that the strength of the plate by itself is improved.

According to the narrow seal chain of the invention, the distance between the inner side surfaces of the both inner plates, the distance between the outer side surfaces of the both outer plates, and the length of the pins are set to be same as those of a standard roller chain even though the narrow seal chain includes seals, and accordingly it can be engaged and wound around standard sprockets, so that a standard chain guide available in the market can be used without change. In addition, standard plastic covers can also be attached as well.

Further, the thickness of the outer plates and the inner plates are reduced, and the hardness of the respective plates is increased to restrain lowering of the strength, and accordingly there arises no problem in terms of dimensions when using the narrow seal chain in the invention instead of the standard chain in the prior art. Furthermore, since the outer width of the inner plates is reduced, the distance between the fulcrums of the pins is reduced, so that the deflection of the pins and the deflection of the plates when the tensile force is applied are reduced, whereby concentration of the stress to plate holes and the pins is alleviated and the chain strength (specifically, fatigue strength) is little affected.

### BRIEF DESCRIPTION OF THE DRAWINGS

FIG. 1A is a plan view showing a narrow seal chain according to an embodiment of the invention;

FIG. 1B is a cross-sectional view taken along a line 1B-1B in FIG. 1A;

FIG. 2 is a graph showing a comparison between a tensile strength of the narrow seal chain and that of a seal chain in the prior art;

FIG. 3 is a graph showing a comparison between fatigue strength of the narrow seal chain and that of the seal chain in the prior art;

FIG. 4A is a plan view showing a standard chain in the prior art;

FIG. 4B is a cross-sectional view taken along a line 4B-4B in FIG. 4A;

FIG. 5A is a plan view showing the seal chain in the prior art;

FIG. 5B is a cross-sectional view taken along a line 5B-5B in FIG. 5A; and

FIG. 6 is a perspective view of a conveyer chain having plastic covers attached to the standard chain in the prior art.

### DETAILED DESCRIPTION OF THE PREFERRED EMBODIMENTS

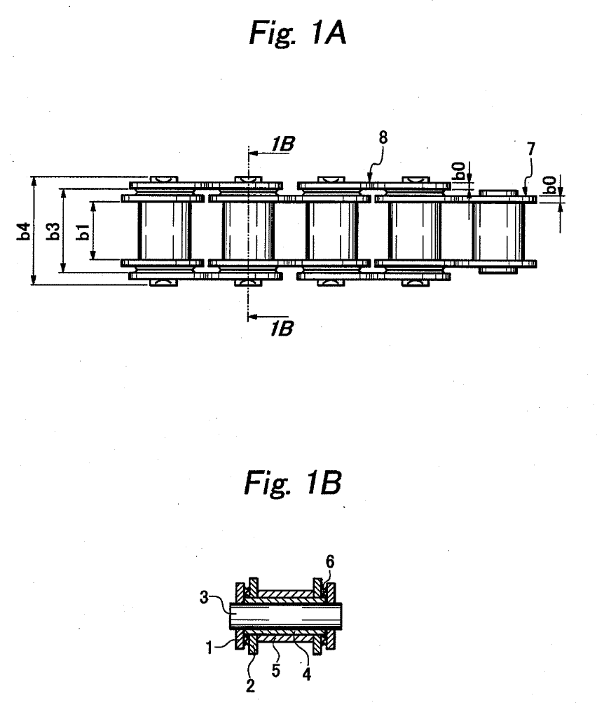

FIGS. 1A and 1B show a narrow seal chain according to the invention, which is configured in an endless form by combining outer links 8, 8, . . . and inner links 7, 7, . . . alternately and bendably coupling the same. The outer link 8 is formed by press-fitting two pins 3 and 3 in holes in a pair of parallel outer plates 1 and 1. The inner link 7 is formed by press-fitting two bushes 4 and 4 into holes in a pair of parallel inner plates 2 and 2 and supporting rollers 5 and 5 on outer peripheries of the bushes 4 and 4 so as to be rotatable about axes thereof. Ring-shaped seals 6 and 6 are sealed between the outer plates 1 and 1 and the inner plates 2 and 2.

When the seal chain is wound around sprockets and travels, the inner links 7, 7, . . . and the outer links 8, 8, . . . are repeatedly deflected with respect to each other and, in this case, the bush 4 of the inner link 7 and the pin 3 of the outer link 8 make sliding rotation with respect to each other. At this time, since the pin 3 and the bush 4 are in metal contact with each other and hence are worn, grease is injected in a gap between the pin 3 and the bush 4 in order to restrain the wear, and is prevented from leaking out by being sealed with the seals 6 and 6.

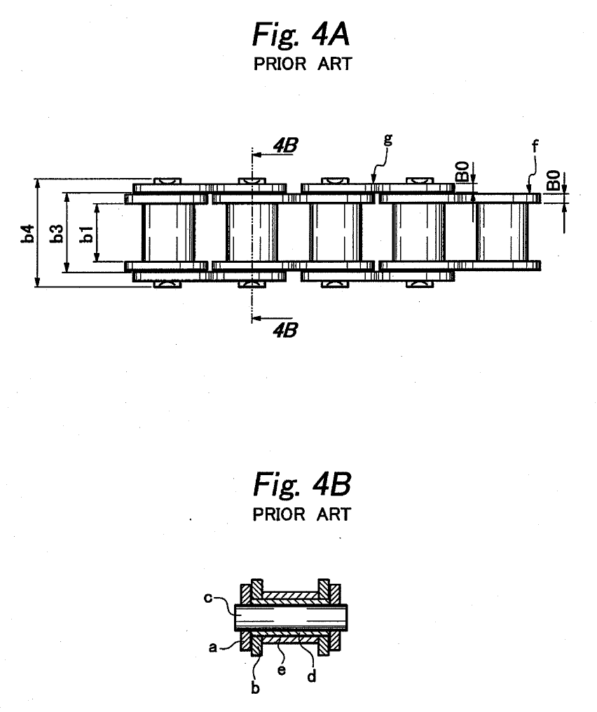

The seal chain according to the embodiment of the invention has same width as a standard chain (ISO606-08A) in the prior art. In other words, a distance b1 between inner side surfaces of the opposed both inner plates 2 and 2 is same as the distance b1 between inner side surfaces of both inner plates (b), (b) of the standard chain shown in FIG. 4A. A distance b3 between inner side surfaces of the both outer plates 1 and 1 is same as the distance b3 between inner side surfaces of both outer plates (a), (a) of the standard chain. Then, a length b4 of the pin 3 is same as the length of a pin (c) of the standard chain in the prior art. However, a slight difference in length of the pin 3 does not cause any problem in strength, and variations on the order of 10% are allowed.

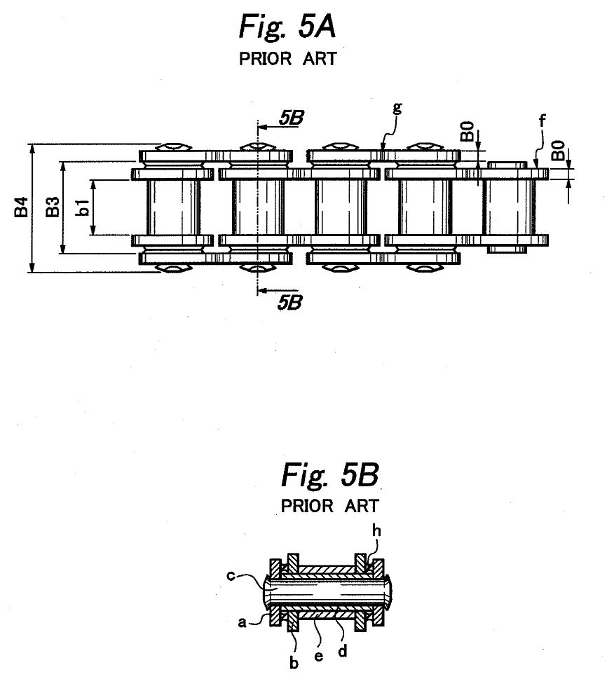

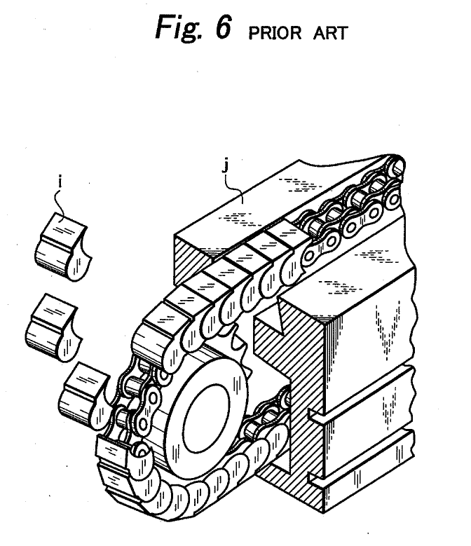

As described above, in order to make the distance b1 between the inner side surfaces and the distance b3 between the inner side surfaces of the outer plates 1 and 1 of the narrow seal chain according to the invention to be equivalent to those of the standard chain, thickness b0 of the outer plate 1 and the inner plate 2 of the narrow seal chain in the invention are set to be thinner than a thickness B0 of the outer plate (a) and the inner plate (b) of the standard chain (see FIGS. 5A and 5B). Also, the width (gauge) of the seal 6 is set to be smaller than that of a seal (h) used in the seal chain in the prior art.

According to the narrow seal chain in the invention shown in FIG. 1 has a thickness b0 of the outer plate 1 and the inner plate 2 is 1.25 mm, which is thinner than the thickness (B0=1.5 mm) of the outer plate (a) and the inner plate (b) of the standard chain of ISO606-08A shown in FIGS. 4A and 4B by 0.25 mm.

The gauge of the seal 6 in a state of being interposed between the outer plate 1 and the inner plate 2 is 0.75 mm, which is thinner than the gauge 1.375 mm of the seal (h) in a state of being interposed between the outer plate (a) and the inner plate (b) of the seal chain in the prior art. Therefore, a distance between outer side surfaces of the both outer plates 1 and 1 is 14.45 mm, and is equal to the case of the standard chain. The length of the pin 3 is 16.5 mm, which is same as the length of the pin (c) of the standard chain.

Equalizing the distance b1 between the inner side surfaces of the both inner plates 2 and 2, the distance between the outer side surfaces of the both outer plates 1 and 1, and the length of the pin 3 with those of the standard chain is not limited to the case of ISO606-08A, but is also same in the cases of ISO606-10A and ISO606-12A. There is also a case where the seal chain is configured as a multi-row seal chain instead of a single seal chain, and the narrow seal chain according to the invention may be wound around the same standard sprockets by configuring the distance b1 between the inner side surfaces of the both inner plates 2 and 2 to be same as the distance between the outer side surfaces of the both outer plates 1 and 1.

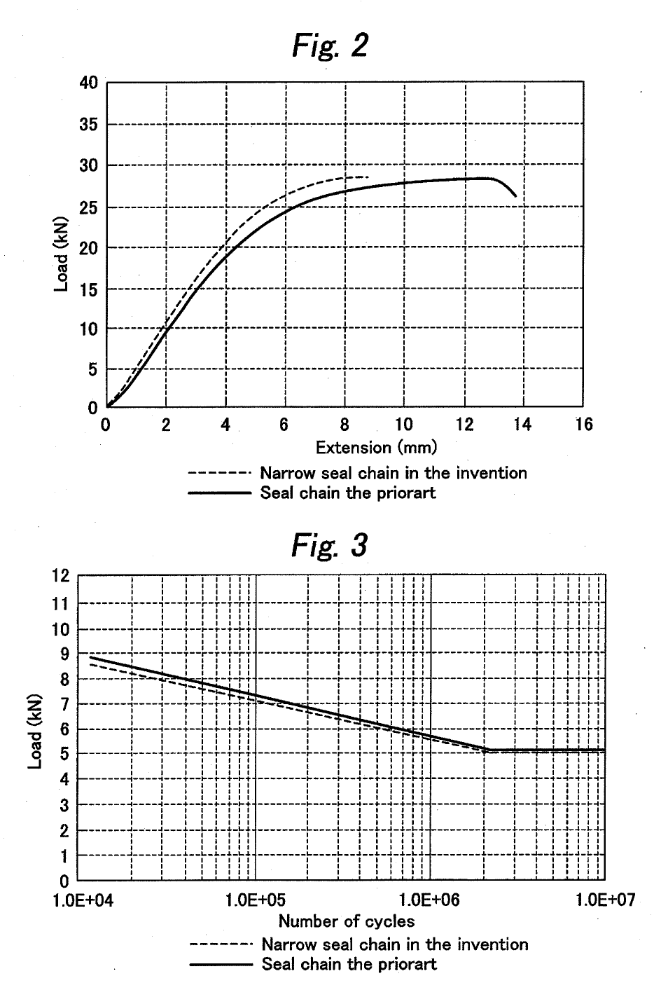

FIG. 2 shows a result of a tensile test showing the relation between the elongation of the narrow seal chain and the load according to the invention in comparison with the seal chain in the prior art. According to this graph, the elongation is smaller in the case of the narrow seal chain in the invention if the load is same. In other words, the narrow seal chain of the invention is able to carry a larger load. It seems to be because the distance between fulcrum points for supporting the pin 3 is reduced by reducing the thickness of the inner and outer plates 2 and 1, and bending deflection of the pin 3 is restrained thereby.

FIG. 3 is a graph showing a result of a fatigue strength test, showing the fatigue strength of the narrow seal chain of the invention in comparison with the seal chain in the prior art. According to this graph, the fatigue strength of the narrow seal chain of the invention is slightly lower than that of the seal chain in the prior art. The narrow seal chain of the invention has the same chain width as the standard chain by reducing the thickness of the outer plate 1 and the inner plate 2.

Therefore, the individual strength of the outer plate 1 and the inner plate 2 is inevitably lowered. However, with the reduction of the thickness of the outer plate 1 and the inner plate 2, the distance between the fulcrums of the pin 3 (distance between the both outer side surfaces of the inner link) is reduced and, consequently, the bending deflection of the pin 3 is reduced, and concentration of the stress on the plate holes or the pins is alleviated. Consequently, even when the thickness of the outer plate 1 and the inner plate 2 is reduced, significant lowering of the fatigue strength of the narrow seal chain is not resulted.

In order to satisfy the dimensions (inner width b1, total width b4) of the ISO power transmission roller chain, the thickness b0 of the plate is reduced to a thickness smaller than the seal chain in the prior art, the inner width b1 and the total width b4 of the inner link complies with the ISO power transmission roller chain (standard chain), an inner width b3 of the outer link is set to make an amount of deflection of the pin expressed by V=5W(b3)⁴/384EI to be 70% or less of the seal chain in the prior art, and the thickness b0 of the plate is set to be 75% or more of the seal chain in the prior art.

Here, V is the amount of deflection of the pin, W is a force applied to the pin (tensile force applied to the chain), E is a Young's modulus, and I is a second moment of area.

By setting the dimensions to reduce the amount of deflection of the pin 3 and the amount of deflection of the plate, even though the thickness b0 of the plate is small, concentration of the stress to the holes of the plate is reduced and the fatigue strength equivalent to the seal chain in the prior art is achieved. By setting the thickness b0 of the plate to be 75% or more, a metal mold used in the prior art may be utilized without change.

In contrast, steel is used as a material of the respective parts which constitute the chain, and the tensile strength and an impact strength equivalent to those of the seal chain in the prior art are achieved by employing steel containing 0.42 mass % or more carbon (C), 0.15 to 0.35 mass % silicon (Si), 0.6 to 0.9 mass % manganese (Mn), 0.03 mass % or less phosphorus (P), 0.035 mass % or less sulphur (S), 0.2 mass % or less chromium (Cr), and 0.2 mass % or less nickel (Ni), which has a mixed structure of bainite and martensite as a heat treated structure, contains residual austenite of 20% or less, and has a hardness of 45 HRC or higher, for respective parts other than the seal.

What is claimed is:

1. A narrow seal chain comprising: outer links having a pair of outer plates and two pins coupling the outer plates; inner links having two bushes configured to couple a pair of inner plates and rollers fitted on an outer peripheries of the bushes; a ring seal sealed between the outer plate and the inner plate, the outer links and the inner links being coupled alternately and bendably,
wherein the distance between inner side surfaces of the both inner plates and the distance between outer side surfaces of the both outer plates are set to be same as those of a standard chain, and the length of the pin is set to be same as that of the standard chain or the difference in length of the pin is set to be within 10% of that of the standard chain by reducing the thickness of the outer plates and the inner plates.

2. The narrow seal chain according to claim 1, wherein an inner width b3 of the outer link is set to make an amount of deflection of the pin expressed by V=5W(b3)⁴/384EI, where b1 (mm) is an inner width of the inner link, b4 (mm) is a total width of the same, V is the amount of deflection of the pin, W(N) is a force applied to the pin (tensile force applied to the chain), and EI is a Young's modulus, to be 70% or less of a standard seal chain, and a thickness b0 of the plate is set to be 75% or more of the standard seal chain.

3. The narrow seal chain according to claim 1, wherein the outer plates and the inner plates are formed of steel containing C: 0.42 mass % or more, Si: 0.15 to 0.35 mass %, Mn: 0.6 to 0.9 mass %, P: 0.03 mass % or less, S: 0.035 mass % or less, Cr: 0.2 mass % or less, and Ni: 0.2 mass % or less, which has a mixed structure of bainite and martensite as a heat treated structure, contains residual austenite of 20% or less, and has a hardness of 45 HRC or higher.
